(19) United States
(12) Patent Application Publication
(10) Pub. No.: US 2001/0040841 A1
(43) Pub. Date: Nov. 15, 2001

(54) Recording method and medium for optical near-field writing and magnetic flux reading

(76) Inventors: Han-Ping David Shieh, Hsinchu (TW); Po-Cheng Kuo, Taipei (TW); Wei-Chih Hsu, Taipei (TW)

Correspondence Address: Bo-In Lin, 13445 Mandoli Drive, Los Altos Hills, CA, 94022, US

(21) Appl. No.: 09/737,839

(22) Filed: Dec. 14, 2000

Related U.S. Application Data
(60) Provisional application No. 60/170,908, filed on Dec. 15, 1999.

(51) Int. Cl. G11B 11/00

(52) U.S. Cl. 369/13.06

(57) ABSTRACT

A recording method including a read/write optical assembly combining near-field optical writing and magnetic flux reading is invented. The multi-layer structure and properties of media suitable for this recording method is disclosed. Near-field optical writing (such as solid immersion lens, SIL) with/without external magnetic field can shrink the size of the recorded spot substantially. The GMR (Giant Magneto-Resistive) or TMR (Tunneling Magneto-Resistive) device has the advantage of high-resolution for sensing magnetic flux. Taking advantage of both devices, a new high-density data recording system, which consists of near-field optical writing and magnetic flux detection, can be developed. Thus, areal recording density of the re-writable optical disk can be increased substantially.

This Application claims a Priority Filing Date of Dec. 14, 1999 benefited from a previously filed Provisional Application No. 60/170,908.

### BACKGROUND OF THE INVENTION

1. Field of the Invention

This invention relates generally to apparatus and method of data reading and writing on storage medium. Specifically, this invention relates to novel apparatuses and methods for reading data from and writing data to data storage medium implemented with optical near-field writing and magnetic flux reading.

2. Description of the Prior Art

Conventional methods and devices implemented for reading data from and writing data to a recording medium are still limited by a technical challenge that the bit-size cannot be conveniently reduced. This limitation still exists even under the condition that the amount of information storage is increased rapidly, benefited from rapid development of technologies in integrated circuits and computer peripheral device manufacturing. In order to get high recording density, many techniques of magnetic recording and optical recording have been disclosed in attempt to achieve even higher storage density.

Specifically, in the field of magnetic recording technology, the area density of hard disk drive (HDD) implemented with the magneto-resistance (MR) and giant magneto-resistance (GMR) head has been increased by more than 60% every year. However, if recording density of HDD continue to increase with this growth rate, the technology will reach the super-paramagnetic limitation (about 40 Gbit/in²) in near future. With such storage density, the thermal fluctuation likely will cause unstable and random magnetization as the size of recording bits decreases.

It has been proposed that optical data storage has higher recording density than magnetic recording. Among the optical recording techniques, magneto-optical (MO) recording offers many excellent properties such as cyclability>10⁶, long-life time over 30 years, high performance, high capacity, portable compact size (3.5″ or 5.25″), and ISO standard. In MO recording system, the size of magnetic domains determines the density of the digital information. The optical data storage technology has potential to form magnetic domains with dimensions down to 60 nm. However, if recorded mark size decreases to sub-micrometer region, a limit of optical diffraction prevents precise detection of such small marks. In order to overcome this limit, shorter wavelength of laser light and higher numerical aperture lens must be used to extend the diffraction limit. However, the production cost of the apparatus implemented with such technology increases significantly.

A data recording system was disclosed by H. Nemoto, H. Saga, H. Sukeda, and M. Takahashi, in a paper entitled “Exchange-coupled magnetic bi-layer media for thermo-magnetic writing and flux detection”, (ISOM'98, pp.190-191, 1998). The data storage system is implemented with a conventional data writing method of thermo-magnetic writing, and a reading method using the MR head instead of the newer technologies including a GMR or TMR head. Obviously, with a conventional thermomagnetic writing method, the written bit size could not be reduced and the resolution of detection is limited by the inherent limitation of the conventional technology. The saturation magnetization at room temperature of their readout layer is not high enough for MR detection, so the spacing between the slider and medium should be as close as possible.

Another related disclosure was published by H. Saga, H. Nemoto, H. Sukeda and M. Takahashi, in “A new recording method combining thermo-magnetic writing and flux detection”, (ISOM'98, pp.188-189, 1998). A GMR head is implemented for reading data and a conventional thermomagnetic head is used for writing data. Smaller bit size is still not achievable due to the limitation of the conventional method of thermomagnetic method in writing data on a recording medium. The two methods described above do not provide method and apparatus for overcoming the limitations as now faced by those of ordinary skill in the art of data recording system and storage medium.

For all of the above reasons, conventional techniques of data recording system and medium are still faced with the technical difficulties that the data-bit size cannot be further reduced and higher data storage density cannot be achieved. There is a need in the art to provide an improved method and system configuration to overcome these difficulties.

### SUMMARY OF THE PRESENT INVENTION

First objective of the present invention is to provide a recording method that includes a read/write functioning assembly combining near-field optical writing and magnetic flux reading. Second objective of this invention is to design a novel recording media in configuration and the magnetic properties suitable for this recording method. There are three requirements for these recording films suitable for near-field optical writing and GMR head reading. These requirements are 1) the magnetic anisotropy of the film is perpendicular to the film plane. 2) The saturation magnetization of at room temperature must be high enough for the sense of GMR head. And, 3) the single-domain size in the film must be small and correspondingly, the magnetic anisotropy constant of the film must be large.

Briefly, in a preferred embodiment, the present invention discloses a read-write device that includes a near-field optical writing means for writing data. The read-write device further includes a magnetic flux reading means for reading data. In a preferred embodiment, the near-field optical writing means further comprising a solid immersion lens (SIL). In another preferred embodiment, the magnetic flux reading means further comprising a magneto-resistance (MR) sensor. In another preferred embodiment, the magnetic flux reading means further comprising a giant magneto-resistance (GMR) sensor. In another preferred embodiment, the magnetic flux reading means further comprising a tunneling magneto-resistance (TMR) sensor. In another preferred embodiment, the read-write device further includes an optical guide for guiding a light to an object lens for projecting the light to the near-field optical writing means for writing data. In another preferred embodiment, the magnetic flux reading means further includes a magnetic coil for picking a magnetic signal. In another preferred embodiment, the read-write device further includes a recording medium for writing data to and reading data from by the read-write device wherein the recording medium comprising a memory layer and a readout layer. In another preferred embodiment, the memory layer comprising a layer of TbFeCo and the readout layer comprising a layer of DyTbFeCo. In another preferred embodiment, the recording medium further comprising a protective layer composed of silicon nitride. In another preferred embodiment, the recording medium further comprising a lubricating layer disposed on top surface of the recording medium. In another preferred embodiment, the memory layer comprising a layer of CoTbX where X is an element other then Co and Th. In another preferred embodiment, the memory layer comprising a layer of CoSmX where X is an element other then Co and Sm.

A method for carrying out a data access by employing a read-write device is also disclosed in this invention that includes steps of employing a near-field optical writing means for writing data. And, the method further includes a step of employing a magnetic flux reading means for reading data. In a preferred embodiment, the method, the step of employing the near-field optical writing means further comprising a step of employing a solid immersion lens (SIL). In a preferred embodiment, the method, the step of employing the magnetic flux reading means further comprising a step of employing a magneto-resistance (MR) sensor. In a preferred embodiment, the method, the step of employing the magnetic flux reading means further comprising a step of employing a giant magneto-resistance (GMR) sensor. In a preferred embodiment, the method, the step of employing the magnetic flux reading means further comprising a step of employing a tunneling magneto-resistance (TMR) sensor. In a preferred embodiment, the method, the method further includes a step of guiding a light with an optical guide to an object lens for projecting the light to the near-field optical writing means for writing data. In a preferred embodiment, the method, the step of employing the magnetic flux reading means further comprising a step of employing a magnetic coil for picking a magnetic signal. In a preferred embodiment, the method, the method further includes a step of employing a recording medium for writing data to and reading data from using the read-write device with the recording medium having a memory layer and a readout layer.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is a side view of schematic diagram of the novel recording method with the optical disk which consists of one readout layer and one memory layer.

FIG. 2 is a side view of schematic diagram of the novel recording method with the optical disk, which consists of one memory layer.

FIG. 3 is a diagram illustrating the magnetic properties of readout layer as a function of temperature.

### DETAILED DESCRIPTION OF THE PREFERRED EMBODIMENT

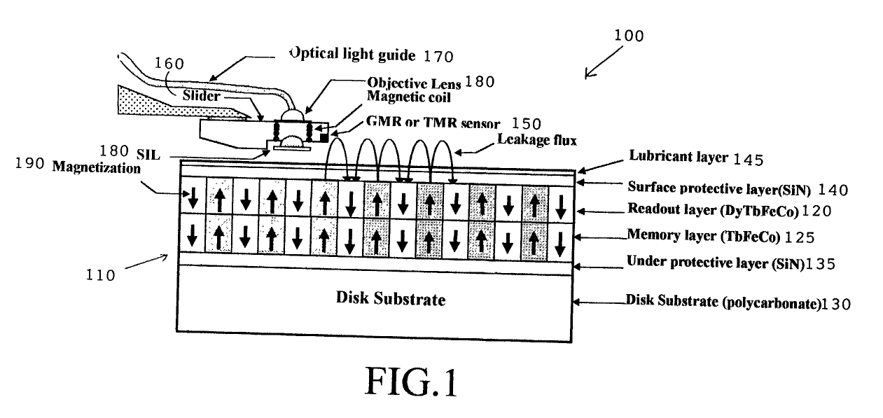

FIG. 1 is a side cross-sectional view of schematic diagram of a novel data recording and access system 100 of this invention with an optical disk 110. The optical disk 110 includes a readout layer 120 and a memory layer 125. This novel data recording and access system 100 features a combination of GMR (or TMR) sensor 150, a near-field optical system with/without magnetic coil on a slider 160. The slider may include an optical light guide 170 such as optical fiber, solid immersion lens (SIL) 180, a magnetic coil 180, and the GMR (or TMR) sensor 150. The recording media 110 includes a disk substrate (Polycarbonate, glass, etc.) 130, a under protective layer (SiN, etc.) 135, the memory layer (TbFeCo, etc.) 125, the readout layer 120 (DyTbFeCo, etc.), a surface protective layer (SiN, etc.) 140, and lubricant layer 145.

In the recording process, perpendicular domains of memory layer 125 are formed by thermo-magnetic writing, which utilizes near-field optics. The near-field writing is different from the conventional thermomagnetic writing. The laser light of the thermo-magnetic writing is incident from the substrate side, and that of the near-field writing is incident from the films side and the flying slider is positioned close to medium surface about 100˜150 nm. The conventional magneto-optical memory layer is not suitable for providing magnetic flux because its magnetization is small at room temperature. One solution is to exchange-couple a readout layer 120 to the conventional magneto-optical memory layer 125. The readout layer 120 copies the magnetization-state of memory layer 125 and generates the magnetic flux to be detected by an GMR (or TMR) sensor. The desirable characteristics of the readout layer 120 are large magnetization at room temperature to provide high flux density and large perpendicular anisotropy to make an accurate copy. In the readout process, a signal is detected from leakage flux by using GMR (or TMR) sensor, which is different from the detection of Kerr rotation angle by conventional magneto-optical recording.

The requirements of these recording films suitable for near-field optical writing and GMR head reading are as the followings. First, the magnetic anisotropy of the film is perpendicular to the film plane. Second, the saturation magnetization 190 of the film at room temperature must be high enough for the sense of GMR head. Third, the single-domain size of the film must be small, i.e. magnetic anisotropy constant of the films 120 and 125 must be large.

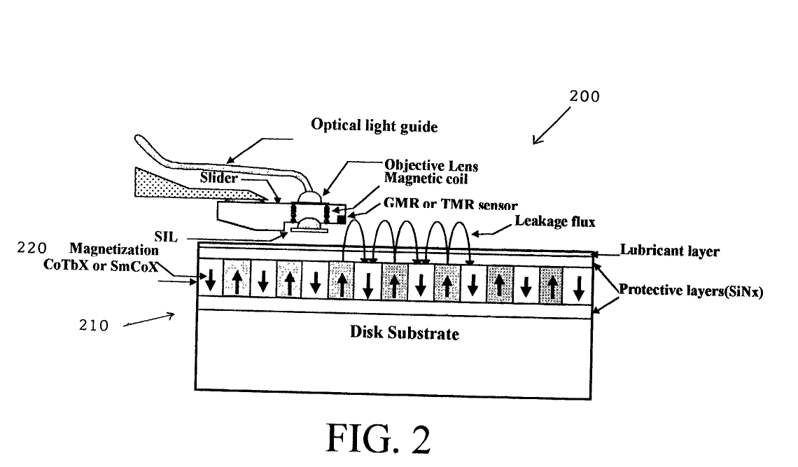

FIG. 2 is a side cross-sectional view of schematic diagram of another data recording and access system 200 of this invention with an optical disk 210. The optical disk 210 includes a memory layer 220. The recording and reproducing method is the same with FIG. 1. The configuration of medium 210 is simpler than that shown in FIG. 1. The magnetic properties of the only memory layer 220 are (1) Curie temperature (Tc) ˜200 degree Celsius, (2) Ms at room temperature is high, (3) magnetic thin films of CoTbX (X are the elements other then Co and Th) and CoSmX (X are the elements other then Co and Sm) is suitable for memory layer.

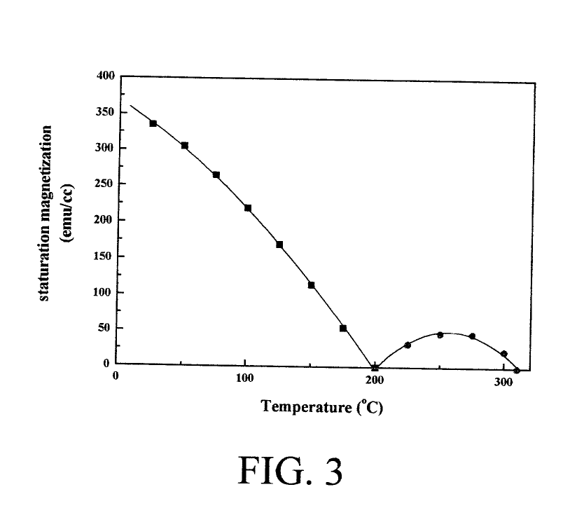

FIG. 3 is a diagram illustrating the magnetic properties of readout layer, e.g., layer 120 or layer 220, as a function of temperature. The thin film has a high recording density. The thin-film medium is provided to process large magnetic perpendicular anisotropy, high coercivity Hc and adequate high saturation magnetization Ms for MR and GMR magnetic heads.

With the near-field optical writing, such as solid immersion lens (SIL), the focus laser spot size is reduced. As a consequence, the recorded spot size is also reduced substantially. The GMR (Giant Magneto-Resistive) or TMR (Tunneling Magneto-Resistive) device has the advantage of high-resolution for sensing magnetic flux. Taking advantage of both methods, a new high-density data recording system, which consists of near-field optical writing and magnetic flux detection, can be developed. Thus, area recording density of the re-writable optical disk will be increased drastically. The recording density can be increased to 100 GB/inch² and beyond in near future by using the blue laser light.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A read-write device comprising:
a near-field optical writing means for writing data; and
a magnetic flux reading means for reading data.

2. The read-write device of claim 1 wherein:
said near-field optical writing means further comprising a solid immersion lens (SIL).

3. The read-write device of claim 1 wherein:
said magnetic flux reading means further comprising a magneto-resistance (MR) sensor.

4. The read-write device of claim 1 wherein:
said magnetic flux reading means further comprising a giant magneto-resistance (GMR) sensor.

5. The read-write device of claim 1 wherein:
said magnetic flux reading means further comprising a tunneling magneto-resistance (TMR) sensor.

6. The read-write device of claim 1 further comprising:
an optical guide for guiding a light to an object lens for projecting said light to said near-field optical writing means for writing data.

7. The read-write device of claim 1 wherein:
said magnetic flux reading means further comprising a magnetic coil for picking a magnetic signal.

8. The read-write device of claim 1 further comprising:
a recording medium for writing data to and reading data from by said read-write device wherein said recording medium comprising a memory layer and a readout layer.

9. The read-write device of claim 1 further comprising:
a recording medium for writing data to and reading data from by said read-write device wherein said recording medium comprising a magnetization layer.

10. The read-write device of claim 8 wherein:
said memory layer comprising a layer of TbFeCo and said readout layer comprising a layer of DyTbFeCo.

11. The read-write device of claim 8 wherein:
said recording medium further comprising a protective layer composed of silicon nitride.

12. The read-write device of claim 8 wherein:
said recording medium further comprising a lubricating layer disposed on top surface of said recording medium.

13. The read-write device of claim 8 wherein:
said memory layer comprising a layer of CoTbX where X is an element other then Co and Th.

14. The read-write device of claim 8 wherein:
said memory layer comprising a layer of CoSmX where X is an element other then Co and Sm.

15. A recording medium for writing data to and reading data from by a read-write device, said recording medium comprising:
a memory layer and a readout layer.

16. The recording medium of claim 15 wherein:
said memory layer comprising a layer of TbFeCo and said readout layer comprising a layer of DyTbFeCo.

17. The recording medium of claim 15 wherein:
said recording medium further comprising a protective layer composed of silicon nitride.

18. The recording medium of claim 15 wherein:
said recording medium further comprising a lubricating layer disposed on top surface of said recording medium.

19. The recording medium of claim 15 wherein:
said memory layer comprising a layer of CoTbX where X is an element other then Co and Th.

20. The recording medium of claim 15 wherein:
said memory layer comprising a layer of CoSmX where X is an element other then Co and Sm.

21. The recording medium of claim 15 wherein:
said readout layer having an identical magnetization as said memory layer.

22. A recording medium for writing data to and reading data from by a read-write device, said recording medium comprising:
a memory layer comprising a magnetization layer having a saturation magnetization ranging from 350 to 100 emu/cc in a room temperature range.

23. A method for carrying out a data access by employing a read-write device comprising:
employing a near-field optical writing means for writing data; and
employing a magnetic flux reading means for reading data.

24. The method of claim 23 wherein:
said step of employing said near-field optical writing means further comprising a step of employing a solid immersion lens (SIL).

25. The method of claim 23 wherein:
said step of employing said magnetic flux reading means further comprising a step of employing a magneto-resistance (MR) sensor.

26. The method of claim 23 wherein:
said step of employing said magnetic flux reading means further comprising a step of employing a giant magneto-resistance (GMR) sensor.

27. The method of claim 23 wherein:
said step of employing said magnetic flux reading means further comprising a step of employing a tunneling magneto-resistance (TMR) sensor.

28. The method of claim 23 further comprising:
guiding a light with an optical guide to an object lens for projecting said light to said near-field optical writing means for writing data.

29. The method of claim 23 wherein:
said step of employing said magnetic flux reading means further comprising a step of employing a magnetic coil for picking a magnetic signal.

30. The method of claim 23 further comprising:
a step of employing a recording medium for writing data to and reading data from using said read-write device with said recording medium having a memory layer and a readout layer.
